(19) United States
(12) Patent Application Publication
(10) Pub. No.: US 2007/0183394 A1
(43) Pub. Date: Aug. 9, 2007

(54) Automatic call origination for multiple wireless networks

(76) Inventors: Deepak Khandelwal, San Diego, CA (US); Rotem Cooper, San Diego, CA (US)

Correspondence Address: QUALCOMM INCORPORATED, 5775 MOREHOUSE DR., SAN DIEGO, CA, 92121, US

(21) Appl. No.: 11/346,723

(22) Filed: Feb. 3, 2006

(51) Int. Cl. H04L 12/66

(52) U.S. Cl. 370/352

(57) ABSTRACT

Techniques for performing automatic call origination for multiple wireless networks are described. A terminal automatically originates a call and supports fallback in case of call origination failure. The terminal selects the most preferred wireless network for the call based on network availability and network selection information. The terminal attempts origination of the call on the selected wireless network. If the call origination fails, then the terminal may select an alternate wireless network based on network availability and the network selection information and may attempt origination of the call on the alternate wireless network. If a VoIP call is preferred over a circuit-switched voice call, then the terminal may first attempt origination of a VoIP call on a packet-switched wireless network. If the VoIP call fails, then the terminal may attempt origination of a circuit-switched voice call on a circuit-switched wireless network.

### BACKGROUND

I. Field

The present disclosure relates generally to communication, and more specifically to techniques for originating a call by a terminal.

II. Background

Wireless communication networks are widely deployed to provide various communication services such as voice, video, packet data, and so on. These wireless networks include wireless wide area networks (WWANs) that provide communication coverage for large geographic areas, wireless local area networks (WLANs) that provide communication coverage for medium-size geographic areas, and wireless personal area networks (WPANs) that provide communication coverage for small geographic areas. Different wireless networks typically have different capabilities, requirements, and coverage areas.

A multi-mode terminal may be capable of communicating with different wireless networks. The terminal may be located within the coverage of zero, one or multiple wireless networks at any given moment. The terminal may be invoked (e.g., by a user) to make a call to obtain a particular communication service. From the user's perspective, it is desirable for the call to be made in a manner that is transparent to the user, who is mainly interested in obtaining the service. However, if the terminal can communicate with different wireless networks, then there may be challenges in deciding how the call should be made.

There is therefore a need in the art for techniques to efficiently handle call origination by a multi-mode terminal.

### SUMMARY

Techniques for performing automatic call origination for multiple wireless networks are described herein. In an aspect, a terminal automatically originates a call (e.g., a voice call or a data call) and supports fallback in case of call origination failure. In an embodiment, the terminal selects the most preferred wireless network for the call based on network availability and network selection information. Network availability refers to the availability of wireless networks that can support the call for the terminal. Network selection information may comprise any information that may be used to select wireless networks for call origination. The terminal attempts origination of the call on the selected wireless network. If the call origination fails, then the terminal may select an alternate wireless network based on network availability and the network selection information and may then attempt origination of the call on the alternate wireless network.

In an embodiment of automatic call origination, wireless networks that are available for a voice call are identified. If a voice over Internet Protocol (VoIP) call is preferred over a circuit-switched voice call, then a first wireless network may be selected from among the available packet-switched wireless network(s) based on the network selection information. Origination of the VoIP call is then attempted on the first wireless network. If the VoIP call fails, then a second wireless network may be selected from among the available wireless network(s) based on the network selection information. If the second wireless network is a circuit-switched wireless network, then origination of a circuit-switched voice call is attempted on the second wireless network. In general, the first and second wireless networks may each be a packet-switched wireless network or a circuit-switched wireless network and may be selected based on preferences indicated by the network selection information.

Various aspects and embodiments of the invention are described in further detail below.

### BRIEF DESCRIPTION OF THE DRAWINGS

The features and nature of the present invention will become more apparent from the detailed description set forth below when taken in conjunction with the drawings in which like reference characters identify correspondingly throughout.

FIG. 1 shows deployment of various wireless networks.

FIG. 2 shows a processing module for a multi-mode terminal.

FIG. 3 shows a network selection table.

FIG. 4 shows a process to automatically originate a voice call.

FIG. 5 shows another process to automatically originate a voice call.

FIG. 6 shows a process for automatic call origination.

FIG. 7 shows another process for automatic call origination.

FIG. 8 shows a block diagram of a multi-mode terminal.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

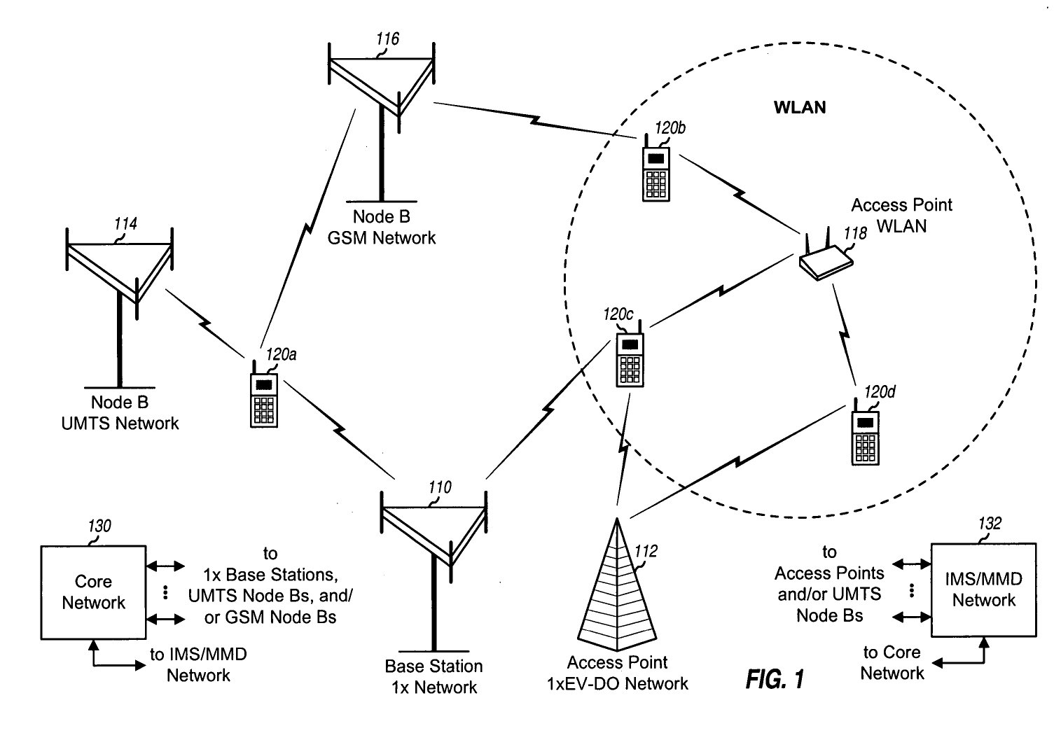

FIG. 1 shows deployment of various wireless networks within a geographic area. These wireless networks include four WWANs and a WLAN.

A WWAN is a wireless network that provides communication coverage for a large geographic area such as, e.g., a city, a state, or an entire country. A WWAN may be a multiple-access network capable of supporting multiple users by sharing the available network resources. Some examples of multiple-access networks include Code Division Multiple Access (CDMA) networks, Time Division Multiple Access (TDMA) networks, Frequency Division Multiple Access (FDMA) networks, and Orthogonal FDMA (OFDMA) networks. A CDMA network may implement a radio technology such as cdma2000, Wideband-CDMA (W-CDMA), and so on. cdma2000 covers IS-2000,IS-856, and IS-95 standards. A CDMA2000 1x (or simply “1x”) network is a wireless network that implements IS-2000 and/or IS-95. A CDMA2000 1xEV-DO (or simply, “1xEV-DO”) network is a wireless network that implements IS-856. A Universal Mobile Telecommunications System (UMTS) network is a wireless network that implements W-CDMA. A TDMA network may implement a radio technology such as Global System for Mobile Communications (GSM). These various radio technologies, standards, and cellular networks are known in the art. W-CDMA and GSM are described in documents from a consortium named “3rd Generation Partnership Project” (3GPP). cdma2000 is described in documents from a consortium named “3rd Generation Partnership Project 2” (3GPP2). 3GPP and 3GPP2 documents are publicly available.

FIG. 1 shows deployment of four WWANs—1x, 1xEV-DO, UMTS and GSM. Each WWAN typically includes many base stations that support communication for the terminals within the coverage of that WWAN. A base station (1x terminology) is typically a fixed station that communicates with the terminals and may also be called a Node B (UMTS and GSM terminology), an access point (1xEV-DO terminology), or some other terminology. For simplicity, FIG. 1 shows only one base station 110 for the 1x network, one access point 112 for the 1xEV-DO network, one Node B 114 for the UMTS network, and one Node B 116 for the GSM network.

A WLAN is a wireless network that provides communication coverage for a medium-size geographic area such as, e.g., a building, a mall, an airport terminal, and so on. A WLAN may implement the IEEE 802.11 family of standards, some other WLAN standard, or some other WLAN radio technology. A Wi-Fi network is a WLAN that implements IEEE 802.11. A WLAN may include any number of access points that support wireless communication for any number of stations. For simplicity, only one access point 118 is shown in FIG. 1. A WLAN station may also communicate directly with another WLAN station via peer-to-peer communication.

The base stations in the 1x network, the Node Bs in the UMTS network, and/or the Node Bs in the GSM networks may couple to a core network 130 that supports roaming and advanced services. Core network 130 may implement ANSI-41, GSM Mobile Application Part (GSM-MAP), and/or some other networking protocol. The access points in the 1xEV-DO network, the access points in the WLAN, and/or the Node Bs in the UMTS network may couple to an Internet Protocol (IP) Multimedia Subsystem (IMS)/Multimedia Domain (MMD) network 132 that can provide multimedia services such as VoIP, video conferencing, streaming data, and so on. Core network 130 may couple to IMS/MMD network 132 via a backbone. Networks 130 and 132 may then provide connectivity for the terminals communicating with the base stations, Node Bs, and access points served by these networks.

Various terminals 120 are dispersed throughout the coverage areas of the wireless networks in FIG. 1. A terminal may be fixed or mobile and may also be called a mobile station (1x terminology), a user equipment (UMTS and GSM terminology), an access terminal (1xEV-DO terminology), a station (IEEE 802.11 terminology), a subscriber unit, and so on. A terminal may be a cellular phone, a handheld device, a wireless device, a personal digital assistant (PDA), a laptop computer, a wireless modem, a handset, and so on. For simplicity, the term “terminal” is used for a device that communicates with a fixed station in much of the description below.

A multi-mode terminal is capable of communicating with multiple wireless networks, which may include WWANs and/or WLANs. A multi-mode terminal may be able to communicate with one or more wireless networks at any given moment depending on the location of the terminal and whether it is within the coverage of the wireless networks. In the example shown in FIG. 1, terminal 120a may communicate with the 1x, UMTS and GSM networks, terminal 120b may communicate with the GSM network and the WLAN, terminal 120c may communicate with the 1x and 1xEV-DO networks and the WLAN, and terminal 120d may communicate with the 1xEV-DO network and WLAN. A terminal may thus be a WWAN device as well as a WLAN station, e.g., a cellular phone with WLAN capability.

In general, a terminal may be capable of communicating with any number of wireless networks of any radio technologies. The automatic call origination techniques described herein may be used for various wireless networks and radio technologies. For clarity, these techniques are specifically described below for a terminal capable of communicating with the five wireless networks shown in FIG. 1. For simplicity, the term “base station” is used for a fixed station in much of the description below.

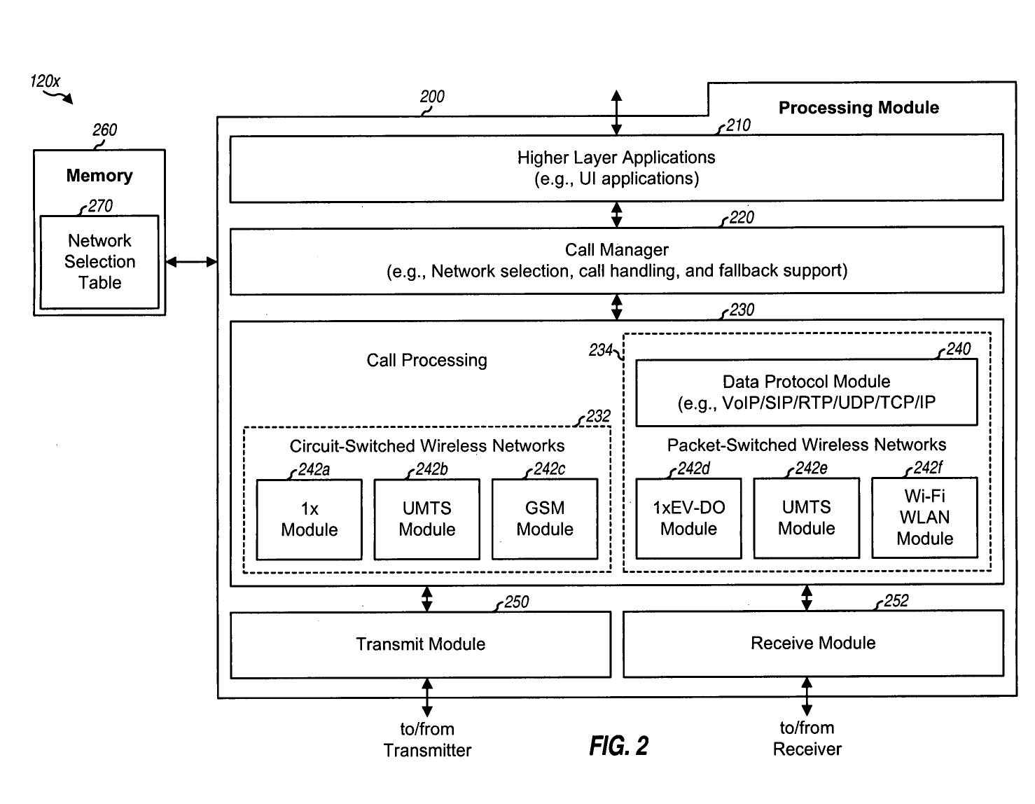

FIG. 2 shows an embodiment of a multi-mode terminal 120x, which may be any of the terminals shown in FIG. 1. In this embodiment, terminal 120x includes a processing module 200 and a memory 260.

Within processing module 200, higher layer applications 210 include various end-user applications such as, e.g., user interface (UI) applications, voice applications that provide voice services, data applications that provide data services, a user browser, an email client, and so on. The voice and data applications may generate requests to originate voice and data calls, respectively.

A call manager 220 controls origination, establishment, and tear down of calls, e.g., as directed by higher layer applications 210. Call manager 220 may provide application programming interfaces (APIs) to allow higher layer applications 210 to request call origination. Call manager 220 may receive indications from higher layer applications 210 to make calls of specific types. Call manager 220 may then select wireless networks to originate calls, control origination of the calls, keep track of the states of the calls, and so on.

A call processing entity 230 performs processing for various radio technologies. In the embodiment shown in FIG. 2, call processing entity 230 includes a section 232 for circuit-switched wireless networks and a section 234 for packet-switched wireless networks. Section 232 includes a module 242a for 1x, a module 242b for UMTS, and a module 242c for GSM. Section 234 includes a data protocol module 240, a module 242d for 1xEV-DO, a module 242e for UMTS, and a module 242f for Wi-Fi. Data protocol module 240 supports various data protocols such as, e.g., Session Initiation Protocol (SIP), Real-time Transport Protocol (RTP), User Datagram Protocol (UDP), Transmission Control Protocol (TCP), and Internet Protocol (IP). These protocols may be used for VoIP, data, and other types of call on packet-switched wireless networks. For example, a VoIP call typically utilizes SIP, RTP, UDP, TCP and IP. Each of modules 242a through 242f performs processing for signaling exchanged with a wireless network of a particular radio technology. As shown in FIG. 2, UMTS supports both packet-switched and circuit-switched calls. In general, call processing entity 230 may include any number of modules for any number of wireless networks of any radio technologies.

A transmit module 250 controls the operation of a transmitter within terminal 120x. A receive module 252 controls the operation of a receiver within terminal 120x. The transmitter and receiver are not shown in FIG. 2. Higher layer applications 210 communicate with call manager 220, which further communicates with call processing entity 230, which further communicates with transmit module 250 and receive module 252. A memory 260 may store a network selection table 270 used to select wireless networks for calls.

As shown in FIG. 2, terminal 120x is capable of communicating with multiple wireless networks. Different wireless networks may have different capabilities and requirements. Furthermore, terminal 120x may be within the coverage of any ones of the wireless networks supported by the terminal.

A user or higher layer applications 210 may desire to make a call of a particular type, e.g., a voice call. The user and the higher layer applications may not be aware of which wireless network(s) are available. Furthermore, the user and the higher layer applications may not care how the call is placed. For example, a voice call may be placed as either (1) a circuit-switched call in the 1x, UMTS or GSM network or (2) a packet-switched call in the 1xEV-DO or UMTS network or the WLAN. For a circuit-switched call, the terminal is assigned a dedicated traffic channel to carry data for the terminal. For a packet-switched call, data is sent as packets via a shared medium. A packet-switched voice call is often referred to as a VoIP call. It may be desirable to hide the intricacies of making a voice call from the user and the higher layer applications and to make call origination transparent to the user and the higher layer applications, which may only be interested in obtaining the underlying voice service.

In an aspect, the call manager automatically originates a call for the user and/or the higher layer applications. The call manager selects the most preferred wireless network for the call based on network availability and network selection information. Network availability refers to the availability of wireless networks that can support the call for the terminal. Network selection information is any information that may be used to select wireless networks for call origination. The call manager attempts origination of the call on the selected wireless network. If the call origination fails, then the call manager may select an alternate wireless network based on network availability and the network selection information and may attempt origination of the call on the alternate wireless network.

The network selection information used for automatic call origination may convey various kinds of information. In an embodiment, the network selection information indicates wireless networks that are supported by the terminal, wireless networks that may be used for each type of call, and preferences among the wireless networks. In other embodiments, the network selection information may convey different and/or additional information used for network selection.

The network selection information may indicate all wireless networks from which the terminal may receive each type of service. For example, the terminal may be able to receive voice service from packet-switched wireless networks such as 1xEV-DO and UMTS networks and WLAN and/or from circuit-switched wireless networks such as 1x, UMTS and GSM networks. The terminal may also be able to receive data service from packet-switched and/or circuit-switched wireless networks. The supported wireless networks are wireless networks from which the terminal may receive service. The supported wireless networks may be determined based on subscriptions with service providers/network operators, roaming agreements between the service providers, the capabilities of the terminal, and so on.

The network selection information may also indicate preferences among all supported wireless networks for each type of service. For example, a VoIP call may be preferred over a circuit-switched voice call. Furthermore, there may be preferences among wireless networks that support the same type of call. For example, a VoIP call on WLAN may be preferred over a VoIP call on 1xEV-DO and UMTS. As another example, a circuit-switched voice call on 1x may be preferred over a circuit-switched voice call on GSM, which may be preferred over a circuit-switched voice call on UMTS. The preferences may be determined based on the requirements for each type of call, the capabilities of the wireless networks, the capabilities of the terminal, subscriptions with the service providers, and so on.

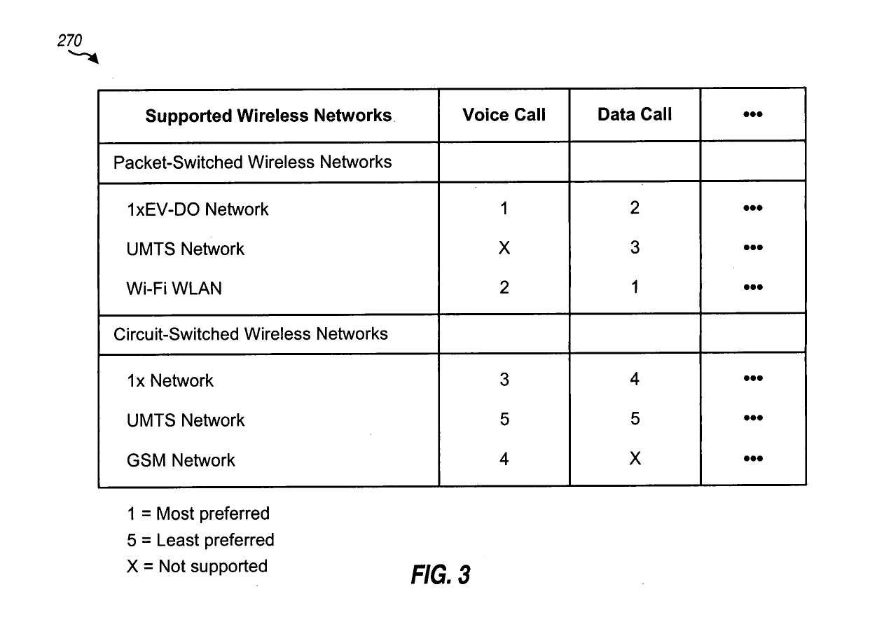

FIG. 3 shows an embodiment of network selection table 270 in FIG. 2, which may be used to select wireless networks for each type of call. In the embodiment shown in FIG. 3, the terminal supports five different wireless networks (1x, 1xEV-DO, UMTS, GSM and WLAN) and at least two different types of call (voice and data). The supported wireless networks include three packet-switched wireless networks (1xEV-DO, UMTS and WLAN) and three circuit-switched wireless networks (1x, UMTS and GSM).

In the embodiment shown in FIG. 3, for a voice call, 1xEV-DO is the most preferred, WLAN is the second most preferred, 1x is the third most preferred, GSM is the fourth most preferred, circuit-switched UMTS is the least preferred, and packet-switched UMTS is not supported. In this embodiment, a VoIP call is preferred over a circuit-switched voice call. Furthermore, a VoIP call on 1xEV-DO is preferred over a VoIP call on WLAN. In the embodiment shown in FIG. 3, for a data call, WLAN is the most preferred, 1xEV-DO is the second most preferred, packet-switched UMTS is the third most preferred, 1x is the fourth most preferred, circuit-switched UMTS is the least preferred, and GSM is not supported. In this embodiment, a packet-switched data call is preferred over a circuit-switched data call.

FIG. 3 shows a specific embodiment of a network selection table. In general, the terminal may support any number and any ones of the currently deployed wireless networks. For example, the terminal may support only 1x and WLAN, only 1x and 1xEV-DO, only UMTS and GSM, or some other combination of wireless networks. The terminal may also support any type of call. For example, the terminal may also support video call, video conference call with both voice and video, multi-media call with both voice and data, Short Message Service (SMS) for text messaging, voice mail notification, and other tele-services, and/or other types of call. Different types of call may be associated with different wireless network preferences.

The network selection information may be provided by the service providers. For example, the network selection information may be part of provisioning information that is loaded into the terminal when it is activated. The network selection information may also be provided, augmented, and/or revised by the user, e.g., based on user preference. The network selection information may be static and applicable for all locations. Alternatively, different network selection tables may be defined for different geographic areas, e.g., similar to a preferred roaming list (PRL) in 1x.

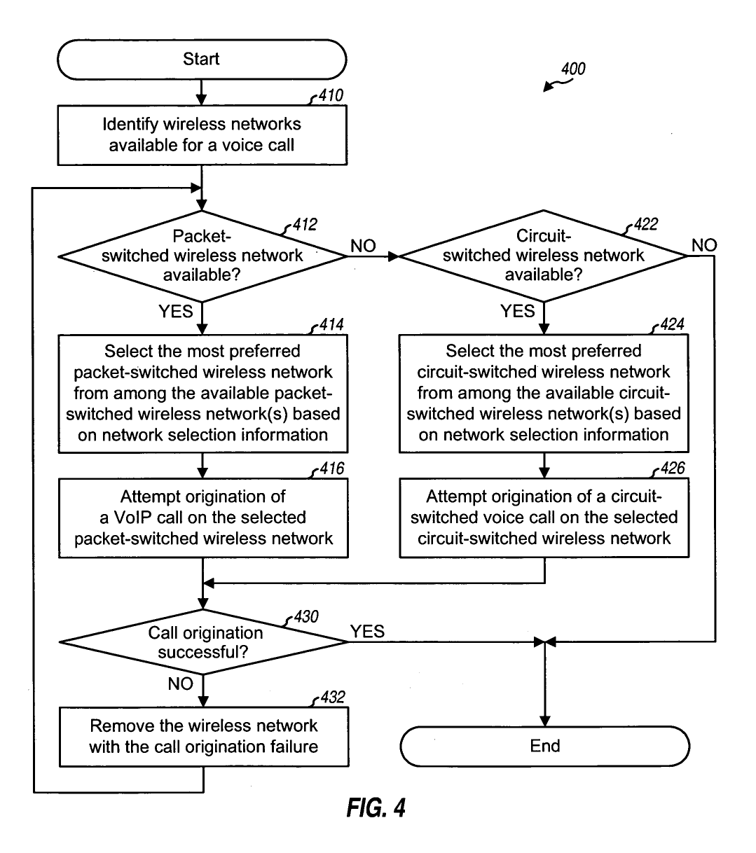

FIG. 4 shows an embodiment of a process 400 for originating a voice call with automatic call origination. In this embodiment, a VoIP call is preferred over a circuit-switched voice call. Initially, wireless networks that are available for the voice call are identified (block 410). The available wireless networks may be (1) wireless networks with which the terminal has registered, (2) wireless networks from which the terminal can receive pilot and/or signaling, (3) wireless networks that are known to be in the vicinity of the wireless networks with which the terminal has registered or can receive pilot and signaling, and/or (4) other wireless networks.

A determination is made whether a packet-switched wireless network is available for a VoIP call (block 412). A packet-switched wireless network may support VoIP if it is appropriately connected, e.g., to an IMS/MMD network. For simplicity, the following description assumes that the packet-switched wireless networks are VoIP capable. If the answer is ‘Yes’ for block 414, then the most preferred packet-switched wireless network is selected from among the available packet-switched wireless network(s) based on network selection information (block 414). Origination of a VoIP call is then attempted on the selected packet-switched wireless network (block 416).

If a packet-switched wireless network is not available and the answer is ‘No’ for block 412, then a determination is made whether a circuit-switched wireless network is available (block 422). If the answer is ‘Yes’, then the most preferred circuit-switched wireless network is selected from among the available circuit-switched wireless network(s) based on the network selection information (block 424). Origination of a circuit-switched voice call is then attempted on the selected circuit-switched wireless network (block 426).

After attempting call origination in block 416 or 426, a determination is made whether the call origination was successful (block 430). If the call origination was successful, then the process terminates. Otherwise, if the call origination failed, then the wireless network with the call origination failure is removed (block 432), and the process returns to block 412 to select another wireless network to attempt call origination. If all available wireless networks have been selected and the answer is ‘No’ for both blocks 412 and 422, then the process terminates.

In the embodiment shown in FIG. 4, call origination is attempted on each available packet-switched wireless network before attempting call origination on a circuit-switched wireless network. In general, the available wireless networks may be selected in any order determined by the network selection information.

Call origination for a VoIP call or a circuit-switched voice call may fail for various reasons related to the terminal, the wireless network, a remote station or server to which the call is placed, and so on. The remote station may be the other user's phone, an entity in the IMS/MMD network, or some other entity. For example, call origination may fail due to unavailable radio service, authorization failure, server failure, and so on.

Call origination for a VoIP call may entail establishing a SIP session with a remote station to which the VoIP call is made. SIP is described in RFC 3261 entitled “SIP: Session Initiation Protocol,” June 2002, which is publicly available. SIP session establishment may fail for various reasons. For example, the terminal may send a SIP request for SIP session establishment and may receive a 3xx response that gives information about the remote station's new location or about alternative services that might be able to satisfy the call. The terminal may also receive a 4xx response that indicates a failure from a SIP server, e.g., a bad request, an unauthorized request, and so on. The terminal may also receive a 5xx response that indicates a server failure, e.g., server internal error, server time-out, and so on. The terminal may also receive a 6xx response that indicates that a server has definitive information about a particular user, not just the particular instance indicated in the SIP request sent by the terminal. The various SIP failures are described in section 21.3 through 21.6 and other sections of RFC 3261.

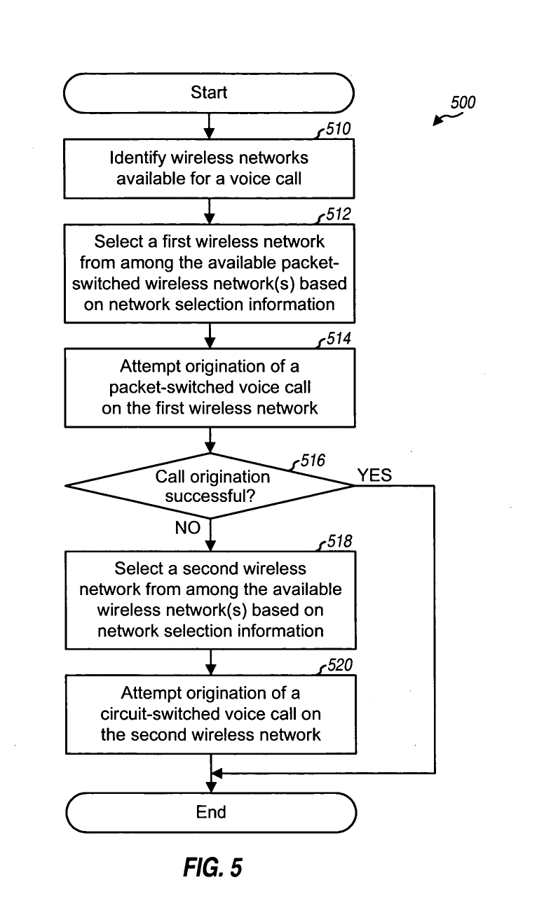

FIG. 5 shows an embodiment of a process 500 for originating a voice call with automatic call origination. Wireless networks that are available for the voice call are identified (block 510). In the embodiment shown in FIG. 5, a VoIP call is preferred over a circuit-switched voice call, and at least one packet-switched wireless network is available. A first wireless network is selected from among the available packet-switched wireless network(s) based on network selection information (block 512). The first wireless network is the most preferred among the available packet-switched wireless network(s), as indicated by the network selection information. Origination of a packet-switched voice call is attempted on the first wireless network (block 514).

A determination is made whether the call origination was successful (block 516). If the call origination was successful, then the process terminates. Otherwise, if the call origination failed, then a second wireless network is selected from among the available wireless network(s) based on the network selection information (block 518). If the second wireless network is a circuit-switched wireless network, then origination of a circuit-switched voice call is attempted on the second wireless network (block 520). Although not shown in FIG. 5, additional wireless networks may be selected, and call origination may be attempted on each selected wireless network until the call origination is successful or has been attempted on all available wireless networks.

In the embodiment shown in FIG. 5, the first wireless network is a packet-switched wireless network and the second wireless network is a circuit-switched wireless network. In other embodiments, the-first and second wireless networks may each be a packet-switched wireless network or a circuit-switched wireless network.

In an embodiment, the first wireless network may be a WWAN (e.g., 1xEV-DO or UMTS) or a WLAN (e.g., Wi-Fi), and the second wireless network is a WWAN (e.g., 1x, UMTS or GSM). In other embodiments, the first and second wireless networks may each be a WWAN or a WLAN.

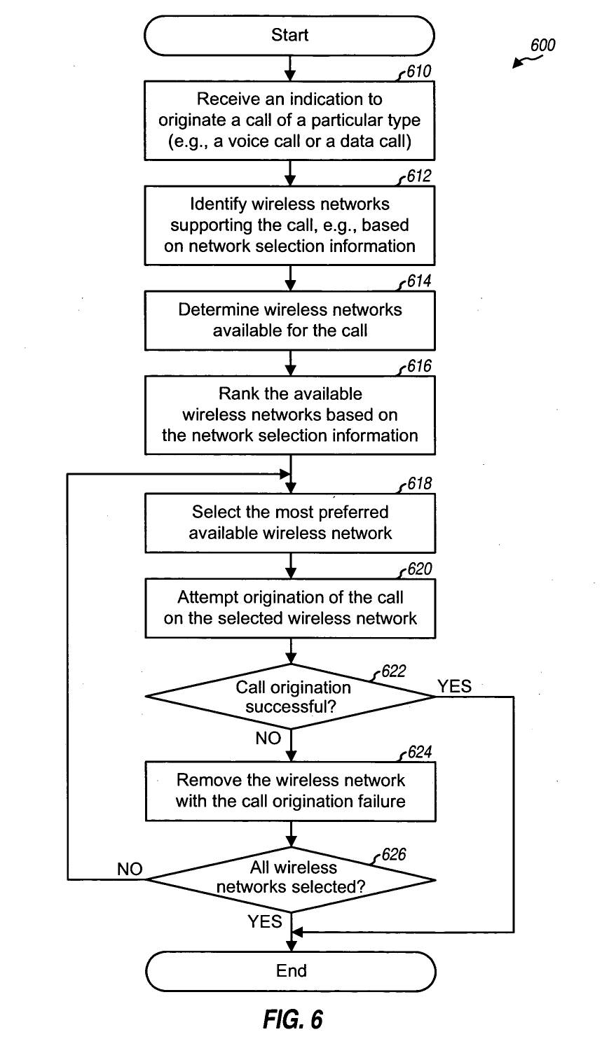

FIG. 6 shows an embodiment of a process 600 for originating a call with automatic call origination. An indication to originate a call of a particular type (e.g., a voice call or a data call) is received (block 610). This indication may come from the user or higher layer applications. Wireless networks supporting the call are identified, e.g., based on network selection information (block 612). The call may be supported by only packet-switched wireless networks, only circuit-switched wireless networks, or both packet-switched and circuit-switched wireless networks.

The wireless networks available for the call are determined, e.g., as described above for FIG. 4 (block 614). Some or all of the supported wireless networks may be available when the call is placed. The available wireless networks are ranked, e.g., from the most preferred to the least preferred, based on the network selection information (block 616).

The most preferred available wireless network is selected (block 618). Origination of the call is then attempted on the selected wireless network (block 620). A determination is then made whether the call origination was successful (block 622). If the answer is ‘Yes’, then the process terminates. Otherwise, the wireless network with the call origination failure is removed (block 624). If all available wireless networks have not been selected, as determined in block 626, then the process returns to block 618 to select the next most preferred available wireless network to attempt call origination. Otherwise, if all available wireless networks have been selected, then the process terminates.

In the embodiment shown in FIG. 6, packet-switched wireless networks and circuit-switched wireless networks may be selected in a specific order determined by the preferences indicated by the network selection information. A circuit-switched or packet-switched call is originated on the selected wireless network, as appropriate.

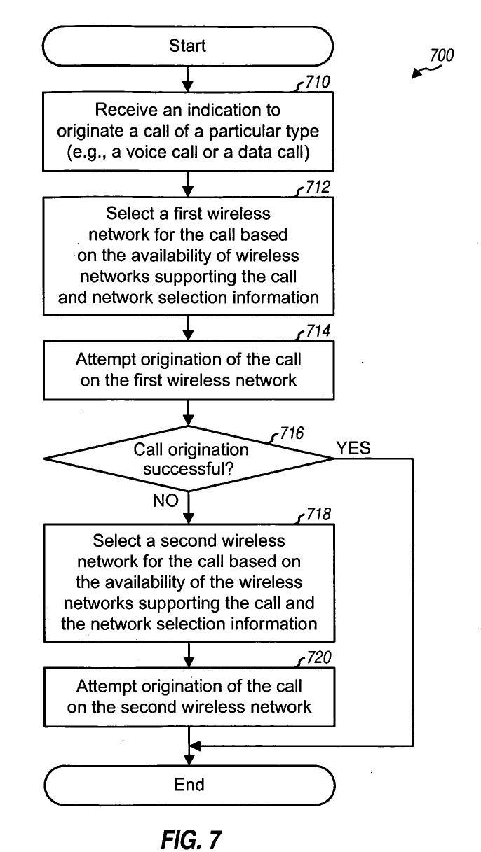

FIG. 7 shows an embodiment of a process 700 for originating a call with automatic call origination. An indication to originate a call of a particular type (e.g., a voice call or a data call) is received (block 710). The call may be supported by multiple wireless networks, and one or more of the supported wireless networks may be available. A first wireless network is selected for the call based on the availability of the wireless networks supporting the call and network selection information (block 712). The network selection information may indicate preferences among the wireless networks supporting the call. The first wireless network may be the most preferred wireless network among the available wireless networks that support the call. Origination of the call is attempted on the first wireless network (block 714).

A determination is then made whether the call origination was successful (block 716). If the answer is ‘Yes’, then the process terminates. Otherwise, a second wireless network is selected for the call based on the availability of the wireless networks supporting the call and the network selection information (block 718). The second wireless network may be the next most preferred wireless network among the available wireless networks that support the call. Origination of the call is attempted on the second wireless network (block 720).

In an embodiment, the first wireless network is a packet-switched wireless network and the second wireless network is a circuit-switched wireless network. In other embodiments, the first and second wireless networks may each be a packet-switched wireless network or a circuit-switched wireless network.

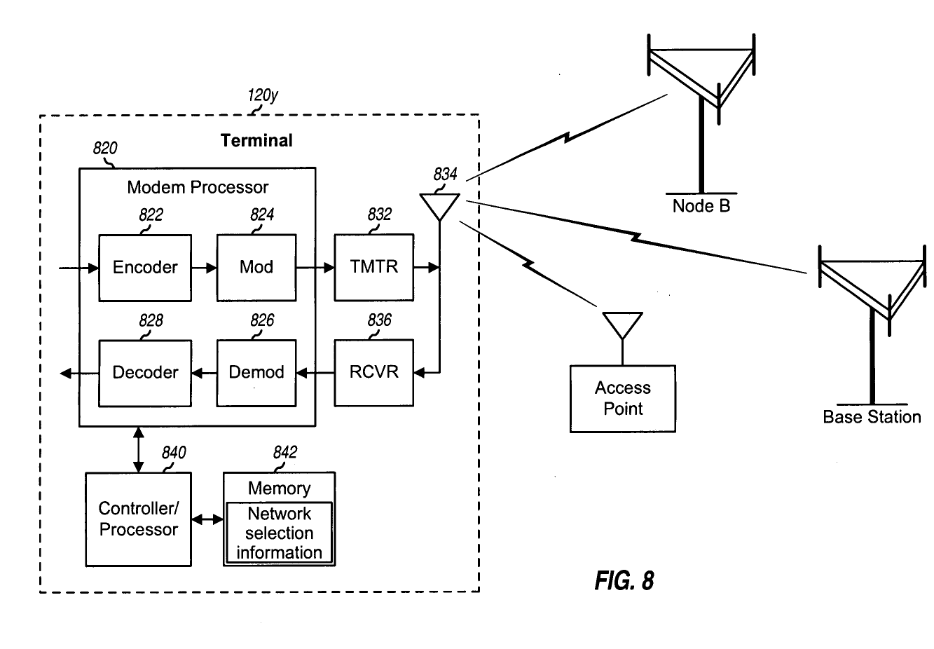

FIG. 8 shows a block diagram of an embodiment of a multi-mode terminal 120y, which is capable of performing automatic call origination for multiple wireless networks. Terminal 120y may be any of the terminals shown in FIG. 1

On the transmit path, an encoder 822 receives data and signaling to be sent by terminal 120y to a base station or Node B in a circuit-switched wireless network or an access point or Node B in a packet-switched wireless network. Encoder 822 processes (e.g., formats, encodes, and interleaves) the data and signaling in accordance with a suitable encoding scheme. A modulator (Mod) 824 further processes (e.g., modulates and scrambles) the coded data and signaling and generates data chips. In general, the processing by encoder 822 and modulator 824 is determined by the wireless network for which data is sent, e.g., 1x, 1xEV-DO, UMTS, GSM or Wi-Fi. A transmitter (TMTR) 832 conditions (e.g., converts to analog, filters, amplifies, and frequency upconverts) the data chips and generates an RF output signal, which is transmitted via an antenna 834. For simplicity, FIG. 8 shows one instance of each processing unit. In general, there may one or multiple modem processors, transmitters, receivers, controllers, and memories for different radio technologies supported by terminal 120y.

On the receive path, antenna 834 receives RF signals transmitted by base stations and Node Bs in circuit-switched wireless networks and/or access points and Node Bs in packet-switched wireless networks. A receiver (RCVR) 836 conditions (e.g., filters, amplifies, frequency downconverts, and digitizes) the received RF signal from antenna 834 and generates data samples. A demodulator (Demod) 826 processes (e.g., descrambles and demodulates) the data samples and provides symbol estimates. A decoder 828 processes (e.g., deinterleaves and decodes) the symbol estimates and provides decoded data. In general, the processing by demodulator 826 and decoder 828 is complementary to the processing performed by the modulator and encoder at the base stations, Node Bs and access points. Encoder 822, modulator 824, demodulator 826 and decoder 828 may be implemented by a modem processor 820.

A controller/processor 840 directs the operation of various processing units at terminal 120y. Controller/processor 840 and/or other processing units within terminal 120y may implement processing module 200 in FIG. 2. Controller/processor 840 may also implement or direct process 400 in FIG. 4, process 500 in FIG. 5, process 600 in FIG. 6, and/or process 700 in FIG. 7. A memory 842 stores program codes and data for terminal 120y. Memory 842 may also store network selection information for the wireless networks supported by terminal 120y and their preferences, e.g., network selection table 270 in FIG. 3.

For clarity, automatic call origination has been described for five specific wireless networks. In general, automatic call origination may be performed for any number of wireless networks and any combination of wireless networks.

The automatic call origination techniques described herein may provide various advantages. First, seamless call origination experience may be provided for the user and the higher layer applications since they do not need to be aware of the intricacies of call origination. The call manager may first attempt call origination on the most preferred wireless network and may handle fallback to another wireless network in case of call origination failure. Second, the complexity of the higher layer applications may be simplified with automatic call origination. The higher layer applications may communicate with the call manager via simple APIs for call origination. The same APIs may be used for all supported wireless networks. The call manager may implement the necessary functions for call origination with each different wireless network. The call manager may be designed by a manufacturer of a chip set used in the terminal. The higher layer applications may be designed by an original equipment manufacturer (OEM) of the terminal. The automatic call origination may simplify the design of the higher layer applications by the OEM. Other advantages may also be obtained with the automatic call origination described herein.

The automatic call origination techniques described herein may be implemented by various means. For example, these techniques may be implemented in hardware, firmware, software, or a combination thereof. For a hardware implementation, the processing units used to perform automatic call origination may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the automatic call origination may be implemented with modules (e.g., procedures, functions, and so on) that perform the functions described herein. The firmware and/or software codes may be stored in a memory (e.g., memory 842 in FIG. 8) and executed by a processor (e.g., processor 840). The memory may be implemented within the processor or external to the processor.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus comprising:
at least one processor configured to attempt origination of a packet-switched voice call on a first wireless network, and to attempt origination of a circuit-switched voice call on a second wireless network if the packet-switched voice call fails; and
a memory coupled to the at least one processor.

2. The apparatus of claim 1, wherein the at least one processor is configured to determine if the first wireless network is available, and to attempt origination of the packet-switched voice call if the first wireless network is available.

3. The apparatus of claim 1, wherein the at least one processor is configured to determine if the second wireless network is available, and to attempt origination of the circuit-switched voice call if the packet-switched voice call fails and the second wireless network is available.

4. The apparatus of claim 1, wherein the memory is configured to store information indicative of wireless networks supported by the apparatus and preferences among the supported wireless networks.

5. The apparatus of claim 1, wherein the at least one processor is configured to select the first wireless network from among at least one packet-switched wireless network and at least one circuit-switched wireless network based on preference information.

6. The apparatus of claim 1, wherein the at least one processor is configured to select the second wireless network from among at least one packet-switched wireless network and at least one circuit-switched wireless network based on preference information.

7. The apparatus of claim 1, wherein the first wireless network is a wireless local area network (WLAN), and wherein the second wireless network is a wireless wide area network (WWAN).

8. An apparatus comprising:
means for attempting origination of a packet-switched voice call on a first wireless network; and
means for attempting origination of a circuit-switched voice call on a second wireless network if the packet-switched voice call fails.

9. The apparatus of claim 8, further comprising:
means for selecting the first wireless network from among at least one packet-switched wireless network and at least one circuit-switched wireless network based on preference information.

10. The apparatus of claim 8, further comprising:
means for determining if the second wireless network is available; and
means for attempting origination of the circuit-switched voice call if the packet-switched voice call fails and the second wireless network is available.

11. A processor readable media for storing instructions operable to:
attempt origination of a packet-switched voice call on a first wireless network; and
attempt origination of a circuit-switched voice call on a second wireless network if the packet-switched voice call fails.

12. The processor readable media of claim 11, and further for storing instructions operable to:
select the first wireless network from among at least one packet-switched wireless network and at least one circuit-switched wireless network based on preference information.

13. The processor readable media of claim 11, and further for storing instructions operable to:
determine if the second wireless network is available; and
attempt origination of the circuit-switched voice call if the packet-switched voice call fails and the second wireless network is available.

14. An apparatus comprising:
a memory configured to store network selection information; and
at least one processor coupled to the memory and configured to select a first wireless network for a call based on availability of wireless networks supporting the call and the network selection information, and to attempt origination of the call on the first wireless network.

15. The apparatus of claim 14, wherein the network selection information indicates preferences among the wireless networks supporting the call, and wherein the first wireless network is a most preferred wireless network among available wireless networks that support the call.

16. The apparatus of claim 14, wherein the at least one processor is configured to select the first wireless network from among at least one packet-switched wireless network and at least one circuit-switched wireless network.

17. The apparatus of claim 14, wherein if the origination of the call fails on the first wireless network the at least one processor is configured to select a second wireless network for the call based on the availability of the wireless networks supporting the call and the network selection information, and to attempt origination of the call on the second wireless network.

18. The apparatus of claim 17, wherein the first wireless network is a packet-switched wireless network and the second wireless network is a circuit-switched wireless network.

19. The apparatus of claim 14, wherein the call is a voice call, and wherein the first wireless network is a packet-switched wireless network.

20. The apparatus of claim 14, wherein the call is a data call, and wherein the first wireless network is a packet-switched wireless network.

21. A method comprising:
selecting a first wireless network for a call based on availability of wireless networks supporting the call and network selection information; and
attempting origination of the call on the first wireless network.

22. The method of claim 21, wherein the selecting the first wireless network comprises
selecting the first wireless network from among at least one packet-switched wireless network and at least one circuit-switched wireless network.

23. The method of claim 21, further comprising:
if the origination of the call fails on the first wireless network,
selecting a second wireless network for the call based on the availability of the wireless networks supporting the call and the network selection information, and
attempting origination of the call on the second wireless network.

24. A processor readable media for storing instructions operable to:
select a first wireless network for a call based on availability of wireless networks supporting the call and network selection information; and
attempt origination of the call on the first wireless network.

25. The processor readable media of claim 24, and further for storing instructions operable to:
select the first wireless network from among at least one packet-switched wireless network and at least one circuit-switched wireless network.

26. The processor readable media of claim 24, and further for storing instructions operable to:
if the origination of the call fails on the first wireless network,
select a second wireless network for the call based on the availability of the wireless networks supporting the call and the network selection information, and
attempt origination of the call on the second wireless network.
